(19) United States
(12) Patent Application Publication
(10) Pub. No.: US 2022/0349726 A1
(43) Pub. Date: Nov. 3, 2022

(54) SYSTEMS AND METHODS FOR MONITORING SAFETY OF AN ENVIRONMENT

(71) Applicant: Christopher Golden, Ladera Ranch, CA (US)

(72) Inventor: Christopher Golden, Ladera Ranch, CA (US)

(21) Appl. No.: 17/865,175

(22) Filed: Jul. 14, 2022

Related U.S. Application Data
(63) Continuation-in-part of application No. 17/178,191, filed on Feb. 17, 2021.
(60) Provisional application No. 62/977,629, filed on Feb. 17, 2020.

(51) Int. Cl. G01C 21/00; G08B 21/02

(52) U.S. Cl. CPC G01C 21/3885; G08B 21/02; G01C 21/383

(57) ABSTRACT

A system and method for monitoring safety of an environment is provided. The system includes a plurality of sensors, a non-transitory memory storing an executable code, and a hardware processor executing the executable code to receive a first input from a first sensor, the first input including a first current condition information, compare the first current condition information with a current condition database, receive a second input from a second sensor, the second input including a second current condition information, compare the second current condition information with the current condition database, determine an event based on the comparison of the first current condition with the current condition database and the comparison of the second current condition with the current condition database, and transmit a signal in response the determination of the event.

### CROSS-REFERENCE TO RELATED APPLICATIONS

This application claims priority to U.S. patent application Ser. No. 17/178,191 filed Feb. 17, 2021, and claims the benefit of that application, the entirety of which is hereby incorporated by reference.

### FIELD OF THE INVENTION

The present disclosure relates generally to the field of collecting, monitoring, and evaluating information related to the safety of an environment and automatically transmitting a signal to alert emergency services in response to determination of an event in the environment.

### BACKGROUND OF THE INVENTION

Historically, monitoring and evaluating the safety of environments, such as swimming pools and buildings, has been tasked to one or more individuals, such as lifeguards and security personnel of various levels, as well as basic equipment like smoke and carbon monoxide detectors. Nonetheless, a common issue associated with these approaches are the susceptibility to human error and/or equipment malfunction, which in certain circumstances can be catastrophic if not handled in an appropriate timeframe or detected altogether. For example, failure to detect smoke from a building fire by either an individual or a smoke detector could result in extensive damage to people and objects within a building; moreover, if and when rescue personnel reach a burning building, navigating a smoke-filled building without a floor plan or layout can be extremely difficult and dangerous. In another example, some pools do not have lifeguards on constant duty not to mention private home pools, so there could be instances in which a distressed or drowning individual in the pool is not detected at all before it is too late.

Sensors, wearable technology, and other applicable mechanisms have recently become integrated in various environments in order to increase the accessibility and quality of data collected in a location. However, there have been issues associated with fully integrating the aforementioned mechanisms into an environment like a building or a swimming pool due to the inability to identify the emergency event occurring in the environment in real-time and immediately transmitting a signal upon determination of an event.

Therefore, a need exists to overcome the problems with the prior art as discussed above. In particular, what is needed is a system and method to collect and analyze various forms of data pertaining to safety within an environment and use the analysis to provide efficient monitoring, maintenance of the environment, and necessary emergency response to ensure environment's safety.

### SUMMARY OF THE INVENTION

The present disclosure is directed to systems and methods for monitoring the safety of an environment that overcomes the hereinabove-mentioned disadvantages of the heretofore-known devices and methods of this general type and that effectively increases overall safety of an environment.

With the foregoing and other objects in view, there is provided, in accordance with the present disclosure, a system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the system to perform the actions.

In one implementation, the safety system for monitoring an environment includes a plurality of sensors, a non-transitory memory storing an executable code, and a hardware processor executing the executable code to receive a first input from a first sensor, the first input including a first current condition information, compare the first current condition information with a current condition database, receive a second input from a second sensor, the second input including a second current condition information, compare the second current condition information with the current condition database, determine an event based on the comparison of the first current condition with the current condition database and the comparison of the second current condition with the current condition database and transmit a signal in response the determination of the event.

In other implementations, the plurality of sensors is communicatively connected using wires.

In other implementations, the wires are part of the electrical wiring of a building.

In other implementations, the safety system further includes an antenna array and the hardware processor further executes the executable code to transmit an environmental mapping signal using the antenna array, wherein the environmental mapping signal is transmitted using wireless technologies.

In other implementations, the environment is a building and the antenna array is an electrical wiring system of the building

In other implementations, the safety system further includes an environmental mapping device including a mapping device display, a mapping device non-transitory memory storing a mapping device executable code, and a mapping device hardware processor executing the mapping device executable code to receive the environmental mapping signal, generate a map of a local area of the environment based on the environmental mapping signal, and display the map of the local area of the environment on the mapping device display.

In other implementations, the environment is a building and the plurality of sensors are integrated into one or more construction elements of the building.

In other implementations, the one or more construction elements of the building integrating the sensors include at least one of an electrical outlet, a light switch, a light fixture, an electrical door sensor, and an integrated smart device.

In other implementations, the integrated smart device is one of a smart appliance, a smart thermostat, a smart speaker, a smart door opener, a smart door lock, a smart doorbell, and a smart building alarm system.

In other implementations, the environment is a building and the event is one of a fire, a carbon monoxide buildup, a water leak, and an environmental control system malfunction.

In other implementations, the plurality of sensors includes at least one of light sensor, a gas sensor, a sound sensor, a temperature sensor, and a motion detector.

In other implementations, the environment is a swimming pool and the event is an individual in distress and wherein the plurality of sensors include at least one of a tidal sensor, an audible sensor, an electrical sensor, a volumetric sensor, an energized water sensor, and an electrified water sensor.

In other implementations, the signal is an emergency request signal transmitted using one of a telephone, an internet connected computer, a mobile phone and a global positioning (GPS) device.

In another implementation, a method for monitoring an environment with a monitoring device including a non-transitory memory and a hardware processor, and the method includes receiving, using the hardware processor, a first input from a first sensor, the first input including a first current condition information, comparing, using the hardware processor, the first current condition information with a current condition database, receiving, using the hardware processor, a second input from a second sensor, the second input including a second current condition information, comparing, using the hardware processor, the second current condition information with the current condition database, determining, using the hardware processor, an event based on the comparison of the first current condition with the current condition database and the comparison of the second current condition with the current condition database, and transmitting, using the hardware processor, a signal in response to determination of the event.

In other implementations, the system further includes an antenna array, the method further includes transmitting an environmental mapping signal using the antenna array.

In other implementations, the environment is a building and the antenna array is an electrical wiring system of the building.

In other implementations, the system further includes an environmental mapping device having a mapping device display, the method further including receiving, using the environmental mapping device, the environmental mapping signal, generating a map of a local area of the environment based on environmental mapping signal, and displaying the map of the local area of the environment on the mapping device display.

In other implementations, the environment is a building and the event is one of a fire, a carbon monoxide buildup, a water leak, and an environmental control system malfunction.

In other implementations, the plurality of sensors includes at least one of a light sensor, a gas sensor, a sound sensor, a temperature sensor, and a motion detector.

In other implementations, the environment is a swimming pool and the event is an individual in distress.

Although the invention is illustrated and described herein as embodied in a safety system and method for monitoring an environment, it is, nevertheless, not intended to be limited to the details shown because various modifications and structural changes may be made therein without departing from the spirit of the invention and within the scope and range of equivalents of the claims. Additionally, well-known elements of exemplary implementations of the invention will not be described in detail or will be omitted so as not to obscure the relevant details of the invention.

Other features that are considered as characteristic for the invention are set forth in the appended claims. As required, detailed implementations of the present invention are disclosed herein; however, in some implementations, the disclosed implementations are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, in some implementations, the terminology used herein is for the purpose of describing particular implementations only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time.

In the description of the implementations of the present invention, it should be noted that, unless otherwise clearly defined and limited, terms such as “installed”, “coupled”, “connected” should be broadly interpreted, for example, it may be fixedly connected, or may be detachably connected, or integrally connected; it may be mechanically connected, or may be electrically connected; it may be directly connected or may be indirectly connected via an intermediate medium. As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. The terms “program,” “software application,” and the like as used herein, are defined as a sequence of instructions designed for execution on a computer system. A “program,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system. Those skilled in the art can understand the specific meanings of the above-mentioned terms in the implementations of the present invention according to the specific circumstances.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various implementations and explain various principles and advantages all in accordance with the present disclosure.

FIG. 1 depicts a diagram of an exemplary safety system for monitoring an environment, according to one implementation of the present disclosure;

FIG. 2 depicts a diagram of an exemplary mapping device, according to one implementation of the present disclosure;

FIG. 3 depicts a diagram of an exemplary safety system for monitoring an environment, according to one implementation of the present disclosure;

FIG. 4 illustrates an exemplary safety system monitoring an event occurring in a swimming pool environment, according to one implementation of the present disclosure;

FIG. 5 illustrates an exemplary safety system monitoring an event occurring in a building environment, according to one implementation of the present disclosure;

FIG. 6 is a flowchart showing an exemplary method for monitoring an environment, according to one implementation of the present disclosure;

FIG. 7 is a flowchart showing an exemplary method for monitoring an environment, according to one implementation of the present disclosure; and

FIG. 8 is a flowchart showing an exemplary method of using a mapping device for monitoring an environment, according to one implementation of the present disclosure.

### DETAILED DESCRIPTION

While the specification concludes with claims defining the features of the invention that are regarded as novel, it is believed that the invention will be better understood from a consideration of the following description in conjunction with the figures, in which like reference numerals are carried forward. In some implementations, the disclosed implementations are merely exemplary of the invention, which can be embodied in various forms.

The present invention provides a novel and efficient system and method for monitoring the safety of an environment configured to actively collect data from sensors and nodes (network nodes) from the environment in real-time and compare the collected data with a database to determine an event and transmit a signal in response to the determination of the event. In some implementations, the system may aggregate the collected data in a scalable manner in order to generate operational thresholds associated with the sensors of the environment. These thresholds may be utilized to determine or calibrate baseline information of the environment associated with the applicable sensor or node is utilized in order to allow a processor communicatively coupled to the sensors and nodes to perform functions on components within the environment in order to determine an event and transmit a signal to address the overall safety of the environment. Implementations of the invention provide sensors integrated into the environment, to building construction elements, to smart devices, to fixtures, to utilities, to equipment, associated with environment in order to continuously optimize the safety of the environment.

In some implementations, data collected by the sensors and nodes may be entered into a machine learning algorithm in order to generate predictions associated with components of the environment, wherein the predictions may be used by the processor to automatically generate alerts and notifications relating to issues, inefficiencies, and/or emergencies of the environment, and subsequently automatically apply functions to rectify the issues and/or inefficiencies of the environment. The system and methods described herein may be configured to increase and optimize performance and safety within an environment via the scalable collection of data, optimizing of said data in real-time, and application of functions to components of the environment based on predictions and analysis derived from the data in a scalable manner. Thus, by automated and scalable processing of the collected data in real-time, the processing cost over network, computation, and storage is reduced in a manner that simultaneously not only maximizes the performance of data processing, but also improves environment safety via application and analysis of the processed data from the environment components and triggering proper emergency response when necessary.

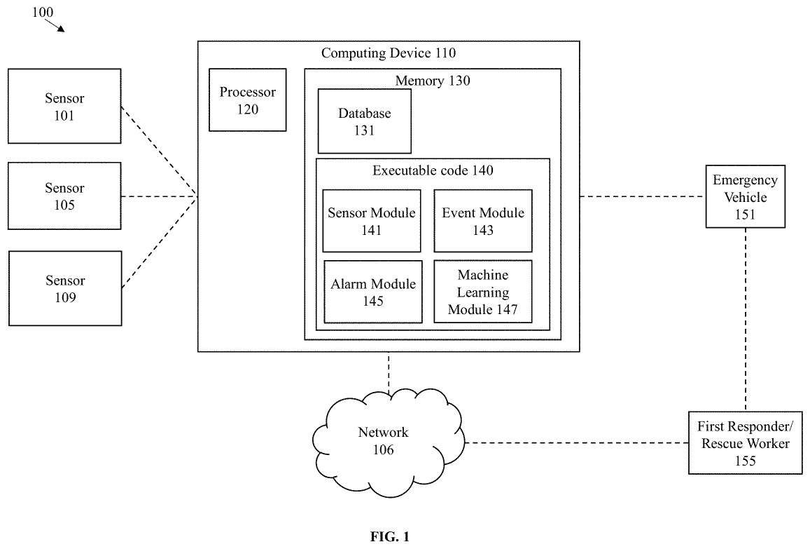

Referring now to FIG. 1, a block diagram of an exemplary safety system 100 for monitoring an environment is depicted, according to one implementation of the present disclosure. System 100 includes sensor 101, sensor 105, sensor 109, network 106, computing device 110, emergency vehicle 151, and first responder/rescue worker 155. As depicted, computing device 110 and rescue worker 155 are each connected to network 106. In some implementations the connection between computing device 110 and network 106 may be wired. In other implementations, the connection between computer device 110 and network 106 may be wireless. In some implementations, the connection between rescue worker 155 and network 106 may be wired. In other implementations, the connection between rescue worker 155 and network 106 may be wireless. Network 106 is a computer network. Network 106 may be a computer network, such as a local area network, a wide area network, a wired network, a wireless network. In some implementations, network 106 may be the internet.

FIG. 1 shows sensor 101, 105, 109. In some implementations, there are a plurality of sensors 101, 105, 109 integrated into an environment. Sensors 101, 105, 109 are communicatively connected using wires. In some implementations, sensors 101, 105, 109 are communicatively connected wirelessly. In some implementations, the wires may be the electrical wiring of a building. Sensor 101, 105, 109 may be integrated into construction elements of the building, including but not limited to lights, lights switches, receptacles, and integrated smart devices, for example. Sensor 101, 105, 109 may detect a variety of conditions in the environment, including at least one of, but not limited to, light, sound, temperature, motion, gas, electricity, and more. In some implementations, network 106 is configured to communicate with a network of computing devices including one or more nodes (network nodes) configured to communicate with or function as the plurality of sensors 101, 105, 109, wherein the nodes may each transmit and receive signals using wireless technologies such as WiFi, Bluetooth, Bluetooth Low Energy (BLE), long range radio frequency (LoRa) technology, radio frequency identification (RFID) active and passive RFID tags, mobile phone connectivity, such as cellular, satellite communicates, LTE, etc.

As shown in FIG. 1, computing device 110 includes processor 120 and memory 130. Processor 120 is a hardware processor, such as a central processing unit (CPU) found in computer devices. Memory 130 is a non-transitory storage device for storing computer code for execution by processor 120, and for storing various data and parameters. As shown in FIG. 1, memory 130 includes database 131 and executable code 140. Database 131 may be a current condition database including calibrated baseline information of the plurality of sensors 101, 105, 109 within the environment. In some implementations, database 131 may include baseline or threshold environmental data, such as acceptable temperature ranges, acceptable gas concentrations for various gasses, acceptable air quality, and acceptable measurements for other environmental data.

Executable code 140 may include one or more software modules for execution by processor 120. As shown in FIG. 1, executable code 140 includes sensor module 141, event module 143, alarm module 145, and machine learning module 147. Sensor module 141 is a software module stored in memory 130 for execution by processor 120 to receive an input from sensor 101, 105, 109 and compare a current condition information from the input with current condition database 131. In some implementations, sensor module 141 is directly associated with a plurality of sensors 101, 105, 109, wherein each of the plurality of sensors are integrated into one or more construction elements of an environment. The one or more construction elements of an environment include at least one of an electrical outlet, a light switch, a light fixture, an electrical door sensor, and an integrated smart device. In some implementations, hardware processor 120 executes the executable code to receive a plurality of inputs from the plurality of sensors 101, 105, 109 and compare current condition information of the plurality of inputs with current condition database 131.

Hardware processor 120 may execute the executable code to receive a first input including a first current condition information from a first sensor. For example, the first input's first current condition information may be a temperature reading from a temperature sensor. Sensor module 141 may then compare the temperature reading with baseline temperature information for the environment stored in current condition database 131 to ascertain whether the temperature reading falls above or below the baseline temperature information for the environment stored in current condition database 131. Furthermore, hardware processor 120 may further execute executable code 140 to receive a second input including a second current condition information from a second sensor. For example, the second input's second current condition information may be an air quality reading from an air quality sensor. Sensor module 141 may then compare the air quality reading with the safe or standard air quality information for the environment stored in current condition database 131 to ascertain whether the air quality reading falls within the safe range of standard air quality information stored in current condition database 131.

As shown in FIG. 1, event module 143 is a software module stored in memory 130 for execution by processor 120 to determine event based on the comparison of the first current condition with current condition database 131 and the comparison of the second current condition with current condition database 131. For example, if the comparison of the temperature reading far exceeds the baseline temperature information of the environment, and if the air quality reading falls outside the safe or standard air quality information, then the determined event may be a fire. In another example, if smoke levels exceed baseline levels of the environment, and if the light sensor detects flickering light, then the determined event may be a fire due to the increased smoke and flickering flames. In some implementations, the event may be one of a fire, a carbon monoxide buildup, a water leak, an environmental control system malfunction, a structural defect, a structural collapse, and a shooting.

In some implementations, the system uses concurrent or coincidental readings to determine an event. Using inputs from two or more sensors, or inputs relating to two or more criteria, may increase the confidence of the determination of an event. For example, if there is a high carbon monoxide reading from a sensor mounted in an electrical outlet near the ground and a high carbon monoxide reading from a sensor mounted in a light switch on a wall, then the determined event may be a carbon monoxide buildup. Having the two carbon monoxide sensors located at different heights, one near the ground and one at a higher mid-level arm height, may indicate the increase of carbon monoxide levels throughout the room or environment. Further, the coincidental consistent readings between two separate sensors may increase the confidence in the determination an event and reliability of the system.

As shown in FIG. 1, Alarm module 145 is a software module stored in memory 130 for execution by processor 120 to transmit a signal in response to the determination of the event. In some embodiments, the signal is an emergency request signal transmitted using one of a telephone, an internet connected computer, a mobile phone, and a global positioning system (GPS) device. In some embodiments, the emergency request signal is transmitted to dispatch emergency vehicle 151 and first responder/rescue worker 155. For example, if event is a fire, alarm module 145, using processor 120, would transmit the signal to notify the fire department and dispatch at least a fire truck as emergency vehicle 151 and firefighters as rescue worker 155. The transmitted signal may also dispatch an ambulance as emergency vehicle 151 and paramedic as rescue worker 155. Based on the comparisons of the current condition information with current condition database 131, alarm module 145 may determine the appropriate emergency request signal to transmit for dispatch of applicable emergency vehicle 151 and rescue worker 155 and. Emergency vehicle 151 may be at least one of an ambulance, a fire truck, a police car, and a helicopter. First responder/rescue worker 155 may be at least one of a paramedic, an emergency medical technician (EMT), a firefighter, a police officer, a lifeguard, a law enforcement officer, and more.

In some implementations, machine learning module 147 is a software module stored in memory 130 for execution by processor 120 to gather and combine information or recordings gathered by sensors 101, 105, 109 and generate predictions and executable instructions configured to adjust or calibrate data of environment stored in current condition database 131. In some implementations, machine learning module 147 applies machine learning algorithms in order to generate predictions relating to different factors and generate predictions. In some implementations, sensors 101, 105, 109 may continuously or periodically acquire temperature data, air quality data, and other applicable data over a period of time allowing machine learning module 147 to generate predictions relating to fluctuations that may occur over time. For example, temperatures are generally lower during the winter months than during the summer months, therefore a high temperature reading from at least one sensor 101, 105, 109 during the summer months if compared with current condition database 131 value from winter months could contribute to erroneous event determination and signal transmission. In some implementations, machine learning module 147 compares compiled recordings and “learns” the differences of values from each season and then generates the baseline or threshold database 131 values in accordance with the season. Machine-learned predictions may be generated regularly, such as hourly, daily, weekly, monthly, annually, or other time period. Newly acquired or fluctuating data may be used to adjust and/or update current condition database 131.

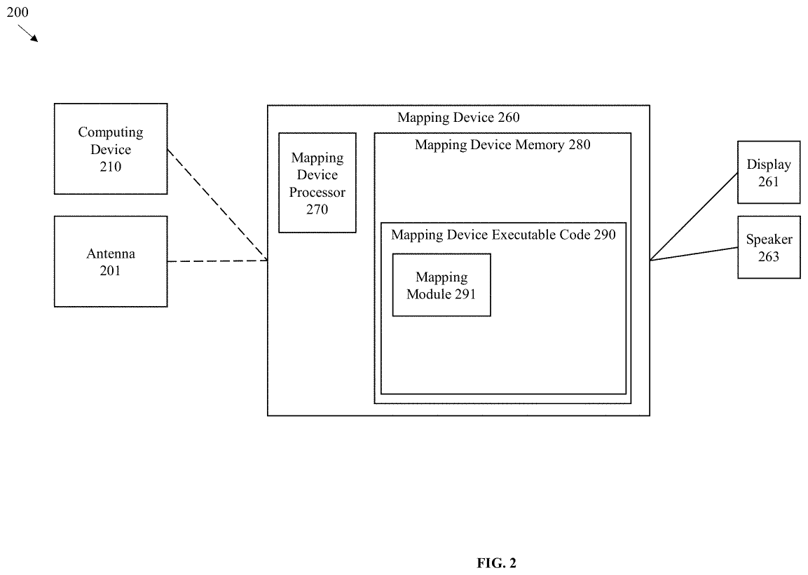

FIG. 2 shows a block diagram 200 of an exemplary mapping device 260, according to one implementation of the present disclosure. In some implementations, safety system 100 further includes mapping device 260. As shown in FIG. 2, system 200 includes antenna 201, computing device 210, mapping device 260, display 261, and speaker 263. As depicted, mapping device 260 is connected to antenna 201 and computing device 210. In some implementations the connection between mapping device 260 and computing device 210 may be wireless. In some implementations, the connection between mapping device 260 and computing device 210 may be wired. In some implementations, mapping device 260 may receive input signals from computing device 210. In some implementations, computing device 210 and mapping device 260 are the same device. Additionally, safety system 200 further includes antenna 201. In some implementations, antenna 201 is an antenna array. In some implementations, antenna 201 transmits signals for detection by mapping device 260. Antenna 201 may be the electrical wiring system of an environment, wherein the environment may be one of a building and a swimming pool.

As shown in FIG. 2, mapping device 260 includes mapping device processor 270 and mapping device memory 280. Mapping device processor 270 is a hardware processor, such as a central processing unit (CPU) found in computing devices. Mapping device memory 280 is a non-transitory storage device for storing mapping device executable code for execution by mapping device processor 270, and for storing various data and parameters. As shown in FIG. 2, mapping device memory 280 includes mapping device executable code 290. In the depicted implementation, mapping device executable code 290 may include one or more software modules for execution by mapping device processor 270.

As shown in FIG. 2, mapping device executable code 290 includes mapping module 291. Mapping module 291 is a software module stored in mapping device memory 280 for execution by mapping device processor 270 to receive an environmental mapping signal transmitted using antenna 201, to generate a map of a local area of the environment based on the environmental mapping signal, and to display the map of the local area of the environment on mapping device display 261. In some implementations, mapping device hardware processor 270 may further execute the mapping device executable code to transmit audio through speaker 263. The audio transmitted through speaker 263 may be directions to navigate to the target area of concern in the environment. In some implementations, the environmental mapping signal is transmitted using wireless technologies such as WiFi, Bluetooth, Bluetooth Low Energy (BLE), long range radio frequency (LoRa) technology, radio frequency identification (RFID) active and passive RFID tags, mobile phone connectivity, such as cellular, satellite communicates, LTE, etc.

In some implementations, mapping device may be one of a cellular phone, a personal digital assistant (PDA), and a portable handheld device. In some implementations, mapping device 260 with display 261 and speaker 263 is integrated into a wearable device, such as a helmet, a pair of goggles or glasses, or a headset in another device worn by a person. For example, the wearable device may further have a head-up display (HUD) or other integrated-display device such that the wearer may better navigate to the targeted area of the environment. For example, if event is a fire and abundant smoke results in little to no visibility, mapping device 260 integrated in a helmet with display 261 may assist rescue worker 155 to navigate to the targeted area of the environment by displaying a map or floorplan of the environment. This way, rescue worker 155 may respond directly to the location of the incident or emergency.

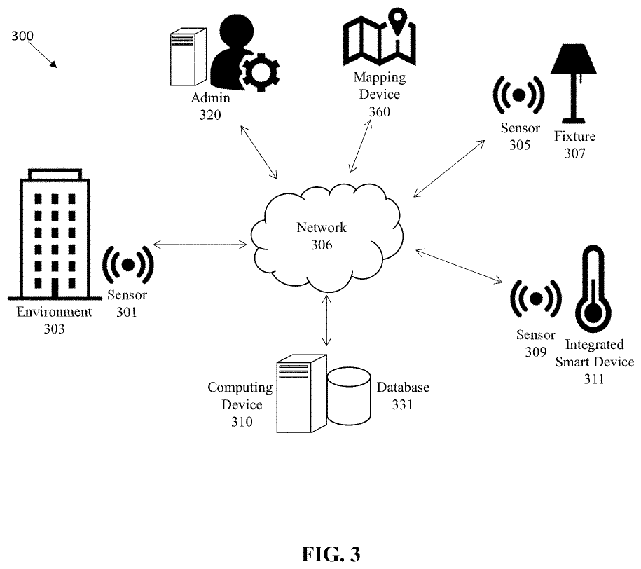

FIG. 3 shows a diagram of an exemplary safety system 300 for monitoring an environment, according to one implementation of the present disclosure. In one implementation system 300 includes a computing device 310 communicatively coupled to database 331, a communicative network 306, first sensor 301 configured to be associated with environment 303, second sensor 305 configured to be affixed to fixture 307, third sensor 309 configured to be associated with integrated smart device 311, mapping device 360, and administrator 320 associated with environment 303. In some implementations, computing device 310, first sensor 301, second sensor 305, third sensor 309, and administrator 320 are communicatively coupled via network 306.

Computing device 310 may be a server, a networked computer, a laptop computer, a tablet computer, a mobile phone, a smart device, such as a smartphone or a smartwatch, or a computing device included in a wearable device like a helmet or goggles located at or within environment 303. In the depicted implementation, environment 303 is a building. In other implementations, environment 303 may be a swimming pool. In some implementations, the plurality of sensors, first sensor 301, second sensor 305, and third sensor 309 are integrated into one or more construction elements of the building. The one or more constructions elements of the building integrating the sensors include at least one of an electrical outlet, a light switch, light fixture 307, an electrical door sensor, magnetic door holder, automatic door holder, door contacts, cabinets, walls, integrated smart device 311. In some implementations, integrated smart device 311 is one of a smart appliance, a smart thermostat, a smart speaker, a smart door opener, a smart door lock, a smart doorbell, and smart building alarm system.

In some implementations, the plurality of sensors, first sensor 301, second sensor 305, and third sensor 309, may be one or more of a gyroscope, accelerometer, infrared sensor, proximity sensor, position sensor, biometric data sensor, pressure sensor, vision/imaging sensor, measurement device, microphone, transducer, capacitance switch, pressure switch, scanner, gas/chemical detector, temperature sensor, radiation sensor, photoelectric sensor, particle sensor, motion detector, leak sensor, humidity sensor, air quality sensor, semiconductor measurer, wind speed sensor, smoke sensor, door contact sensor, window contact sensor, vibration sensor, light sensor, gas sensor, audio detector, sound sensor, or any other applicable sensor configured to collect data.

In one implementation, data collected and/or processed by any of the aforementioned is configured to be analyzed and/or presented on a centralized platform generated by computing device 310 allowing a user or administrator 320 to have access to data or analyses based on data collected by computing device 310, first sensor 301, second sensor 305, and/or third sensor 309 and the respective comparisons with database 331. In some implementations, the centralized platform provided by computing device 310 is configured to include various and/or tiered versions allowing users of the centralized platform to have varying access to particular data sets based upon the applicable entity. For example, administrator 320 is configured to have access to all data collected by first sensor 301, second sensor 305, and third sensor 309 to compare with current condition database 331 and determine event. In some implementations, network 306 is configured to communicate with a network of computing devices 310 including one or more nodes (network nodes) configured to communicate with or function as first sensor 301, second sensor 305, and third sensor 309 wherein the nodes may each transmit and receive signals using wireless technology such as Wi-Fi, Bluetooth, Bluetooth Low Energy (BLE), long range radio frequency (LoRa) technology, radio frequency identification (RFID) active and passive RFID tags, mobile phone connectivity, such as cellular, satellite communications, LTE, etc.

In some implementations, the one or more nodes include a computer processor, computer memory, and wireless connectivity technology, such as LTE, 3G, 2.4 GHZ & 5.0 GHz, Mesh, BLE, BLE Mesh, LoRaWAN, GPS, etc. The computer processor may be a hardware processor. The computer memory may be a non-transitory memory. In some implementations the one or more nodes may be computing devices, wherein examples of computing devices include a laptop computer, a tablet computer, a smartphone, a desktop computer, a Personal Digital Assistant (PDA), and any other mechanism including a hardware processor configured to support sending and receiving wireless communication signals. System 300 illustrates only one of many possible arrangements of components configured to perform the functionality described herein. Other arrangements may include less or more or different components, and the division of work between the components may vary depending on the arrangement.

Computing device 310 may be implemented in hardware, software, or a combination of hardware and software. Network 306 may be a wireless local area network (WLAN), wireless personal area network (WPAN), wireless wide area network (WWAN), universal mobile telecommunications service (UMTS), enhanced packet system (EPS), new radio wireless network (NR), internet, LTE, GSM, WCDMA, 3rd generation partnership project (3GPP), a combination of more than one network and/or more than one type of network, or any other applicable communications network.

In some implementations, first sensor 301, second sensor 305, and third sensor 309 are configured to collect a plurality of environmental data, wherein environmental data is associated with a component of environment 303. As described herein, environmental data may include, but is not limited to a temperature, location data (GPS data), an atmospheric humidity, an air quality measurement, an operational status, a windspeed, audio data, gas/chemical presence, or any other applicable data configured to be associated with an environment. In some implementations, the temperature data may include an ambient temperature, an outside temperature, a change in temperature over time, such as an hour or a work shift. In some implementations, the location data may include Global Positioning Satellite (GPS) data, active or passive radio frequency identification (RFID) position data, Wi-Fi location data, or mobile phone position data.

Environmental data may further include sensor data such as a present location of the sensor, a history of the location data of the sensor at environment 303, on/off time of the sensor, usage info about the sensor, a power level of the sensor, e.g., a present battery charge level for battery operated components, maintenance information about the sensor, such as a maintenance history or a maintenance schedule or data of the sensor, a present working condition of the sensor, e.g., if it is functioning properly or is currently experiencing a malfunction.

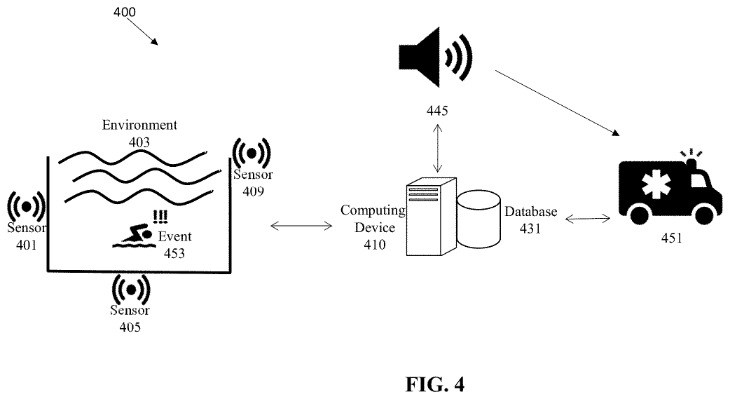

FIG. 4 illustrates an exemplary safety system 400 monitoring event 453 occurring in a swimming pool environment 403, according to one implementation of the present disclosure. In some implementations, environment 403 is a swimming pool with a plurality of sensors integrated at or in the swimming pool. In some implementations, the environment 403 is a swimming pool and event 453 is an individual in distress. In the depicted embodiment, there are a plurality of sensors, first sensor 401, second sensor 405, and third sensor 409. In some embodiments there may be more than three sensors. In some embodiments, there may be less than three sensors. The plurality of sensors, first sensor 401, second sensor 405, and third sensor 409, includes at least one of a tidal sensor, an audible sensor, an electrical sensor, a volumetric sensor, an energized water sensor, an electrified water sensor, and a motion sensor. The plurality of sensors may be located at different locations within, at, and/or near the swimming pool environment 403. As depicted, first sensor 401 is located mid-depth below the water surface. For example, first sensor 401 may be a sub-surface detection pool sensor located below the water surface of a pool that may trigger with a change in water pressure. In the depicted implementation, second sensor 405 is located at or near the base or bottom of swimming pool environment 403. Third sensor 409 is located towards the top or surface of swimming pool environment 403. In some embodiments, first sensor 401, second sensor 405, and/or third sensor 409 may be mounted to the pool deck. In some embodiments, first sensor 401, second sensor 405, and/or third sensor 409, may at least partially extend down into the water or float on the water measuring ripples and waves, water displacement, and disturbance of the water. In some embodiments, the system 400 may distinguish between a small and large disturbance of the water. For example, a small or slight water disturbance could simply be a light breeze, while a large disturbance could be a person falling into the water.

As depicted in FIG. 4, event 453 is an individual in distress in swimming pool environment 403. For example, the individual may have fallen in the pool and unable to swim with no lifeguard or other person present to rescue the individual. Non-transitory memory 130 of computing device 410 stores executable code 140 and hardware processor 120 executes executable code 140. For example, hardware processor 120 executes executable code 140 to receive a first input from first sensor 401 of a first current condition information of change in water pressure in swimming pool environment 403, compare with current condition database 431, receive a second input from second sensor 405 of a second current condition information of motion detection, compare second current condition information with current condition database 431, receive a third input from third sensor 409 of a third current condition information of large water disturbance, compare the third current condition information with current condition database 431, determine event 453 based on aforementioned three respective comparisons of first current condition, second current condition, and third current condition information with current condition database 431, and transmit signal 445 in response to determination of event 453. Signal 445 may be an emergency request signal transmitted using one of a telephone, an internet connected computer, a mobile phone, and a global position system (GPS) device. In some implementations, signal 445 may also trigger an audio alarm, a distress signal and/or SOS signal, to alert those within physical proximity of swimming pool environment 403 of an emergency and/or person(s) experiencing an emergency. In some implementations, instead of the additional step of triggering signal 445 prior to dispatching first responders 551, first responders 551 may immediately be notified and dispatched in response to determination of event 453. In some implementations, both signal 445 and first responders 451 are notified and dispatched simultaneously. As described, there are three separate inputs of current condition information for comparison with current condition database 431. In some implementations, there may be less than three inputs of current condition information for comparison with current condition database 431. In some implementations, there may be more than three inputs of current condition information for comparison with current condition database 431.

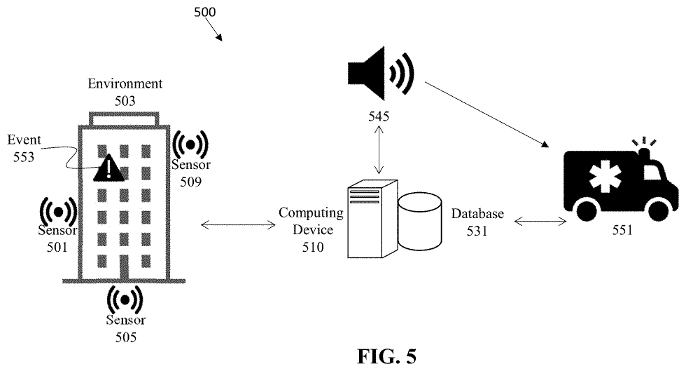

FIG. 5 illustrates an exemplary safety system 500 monitoring an event occurring in a building environment, according to one implementation of the present disclosure. In one implementation, environment 503 is a building with a plurality of sensors integrated into one or more construction elements of building environment 503. The building may be one of an office, a school, a home, and a factory, to name a few. In the depicted embodiment, there are a plurality of sensors, first sensor 501, second sensor 505, and third sensor 509. In some embodiments there may be more than three sensors. In some embodiments, there may be less than three sensors. The plurality of sensors, first sensor 501, second sensor 505, and third sensor 509, includes at least one of a light sensor, a gas sensor, a sound or audio sensor, a temperature sensor, a motion detector, an air quality sensor, a vibration sensor, a smoke sensor, and more. The plurality of sensors may be located at different locations at and/or within building environment 503. As depicted, first sensor 501 is located at roughly a third floor of building environment 503. In some implementations, a plurality of sensors are located at each floor of a building. In the depicted implementation, second sensor 505 is located at or near the first floor entrance of building environment 503. Third sensor 509 is located towards the top floor or roof of building environment 503. In some embodiments, first sensor 501, second sensor 505, and/or third sensor 509 may be mounted or integrated into construction elements such as at least one of an electrical outlet, a light switch, a light fixture, an electrical door sensor, and an integrated smart device. In some embodiments, the integrated smart device is one of a smart appliance, a smart thermostat, a smart speaker, a smart door opener, a smart door lock, a smart doorbell, and a smart building alarm system.

As depicted in FIG. 5, event 553 may be one of a fire, carbon monoxide buildup, a water leak, an environmental control system malfunction, a structural defect, a structural collapse, a shooting, an individual in distress within building environment 503, to name a few. For example, a shooting may be occurring at building environment 503. Non-transitory memory 130 of computer device 510 stores executable code 140 and hardware processor 120 executes executable code 140. For example, hardware processor 120 executes executable code 140 to receive a first input from first sensor 501, an audio sensor, of a first current condition information of loud gunshot noises, compare with current condition database 531, receive a second input from second sensor 505 of a second current condition information of motion detection of individuals exiting building environment 503, compare second current condition information with current condition database 531, receive a third input from third sensor 509 of a third current condition information of motion detection of movement and approximate location of shooter, compare the third current condition information with current condition database 531, determine event 553 based on aforementioned three respective comparisons of first current condition, second current condition, and third current condition information with the current condition database 531, and transmit signal 545 in response to determination of event 553. Signal 545 may be an emergency request signal transmitted using one of a telephone, an internet connected computer, a mobile phone, and a global position system (GPS) device. In some implementations, signal 545 may send a distress or SOS signal to indicate the presence of an emergency and/or person(s) experiencing an emergency. In some implementations, signal 545 may trigger targeted smart locks and safety barricades to isolate shooter and protect other individuals within building environment 503. In some implementations, instead of the additional step of triggering signal 545 prior to dispatching first responders 551, first responders 551 may immediately be notified and dispatched in response to determination of event 553. In some implementations, both signal 545 and first responders 551 are notified and dispatched simultaneously. As described, there are three separate inputs of current condition information for comparison with current condition database 531. In some implementations, there may be less than three inputs of current condition information for comparison with current condition database 531. In some implementations, there may be more than three inputs of current condition information for comparison with current condition database 531.

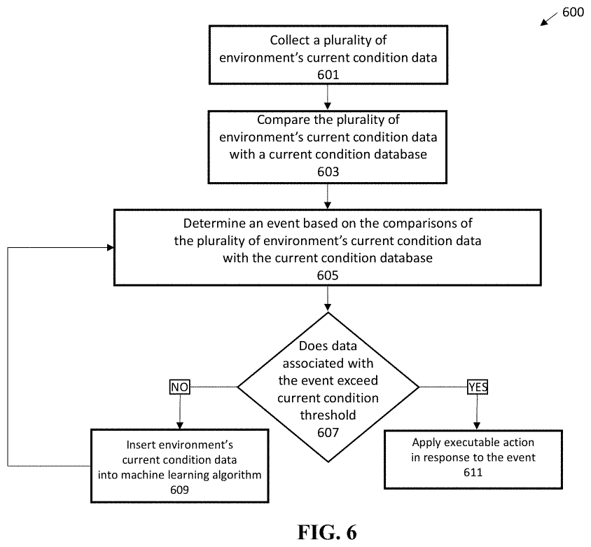

Referring now to FIG. 6, a flowchart 600 showing an exemplary method for monitoring environment 303 is depicted, according to one implementation of the present disclosure. At step 601, collect a plurality of environment's 303 current condition data by receiving, using hardware processor 120, input from first sensor 301 and/or second sensor 305 and/or third sensor 309. Environment's 303 current condition data may be transmitted as input to be received by sensor module 141. In some implementations, sensor module receives 141 input from sensors and compares a current condition information from each input with current condition database 131. In some implementations, environment's 303 current condition data that is collected includes but is not limited to temperature data, smoke detection data, gas detection data, moisture data, sound data, vibration data, motion data, light data, and more.

At step 603, using hardware processor 120, compare the plurality of environment's 303 current condition data with current condition database 131. In some implementations, hardware processor 120 executes executable code from sensor module 141 carrying out the comparison step. Current condition database 131 includes data of the baseline or current condition threshold with which to compare environment's 303 current condition data that is collected.

At step 605, using hardware processor 120, determine event based on respective comparisons of the plurality of environment's 303 current condition data with current condition database 131. In some implementations, hardware processor 120 executes executable code 140 from event module 143 to determine event based on the comparison of the first current condition with current condition database 131 and the comparison of the second current condition with current condition database 131. In some implementations, event may be one of a fire, a carbon monoxide buildup, a water leak, an environmental control malfunction, a structural defect or collapse, and more.

At step 607, hardware processor 120 determines whether the current condition threshold is exceeded based on environment's 303 current condition data associated with event. If the current condition threshold is not exceeded, then step 609 occurs in which environment's 303 current condition data collected by first sensor 301 and/or second sensor 305 and/or third sensor 309 may be transmitted as input into one or more machine learning algorithms via machine learning module 147, and computer device 110 may adjust and/or update current condition threshold in database 131 as needed based on the predictions generated via machine learning module 147. In some implementations, machine learning module 147 may gather and combine information or recordings gathered by sensors 101, 105, 109 and generate predictions and executable instructions configured to adjust or calibrate data of environment stored in current condition database 131.

Otherwise, if the current condition threshold is exceeded, then step 611 occurs in which hardware processor 120 applies an executable action in response to determining event based on the current condition threshold in database 131 being exceeded by the collected environment's 303 current condition information. In some implementations, the executable action may include using hardware processor 120 to execute alarm module 145 and transmit a signal automatically notifying administrator 320, or notifying rescue worker 155, dispatching ambulance, fire truck, and/or applicable emergency vehicle 151, and/or adjusting a functional operation of an applicable component within environment 303. For example, upon collection of environment's current condition information by second sensor 305 indicating that fixture is overheating, the executable action rendered by processor 120 may be checking and/or powering down fixture in order to ensure overall safety of environment 303.

In some implementations, a processor may execute executable code for a plurality of modules, including sensor module 141, event module 143, and alarm module 145, which may receive inputs from at least two or more sensors, compare the same with database 131, determine an event based aforementioned comparisons, and ultimately transmit an signal in response to determined event In some implementations, at least one of the plurality of modules, sensor module 141, event module 143, alarm module 145, and machine learning module 147, may track measurements from a plurality of sensors, including for example a temperature sensor, a smoke sensor, and a motion sensor. In some implementations, if a module, such as sensor module 141, detects certain changes (i.e., exceeding current condition threshold) based on readings from the sensors of environment's 303 current condition information compared with current condition database 131, event module 143 may determine an occurrence of event, and alarm module 145 may transmit a signal in the form of a message or alert based on that determination.

Particular correlations may indicate particular events. In some implementations, event may be determined based on a coincidence of first input and second input each being outside a standard range when compared with current condition database 131. For example, a detected rise in temperature received from a temperature sensor and rise in smoke levels detected by a smoke sensor, correlated with a sudden halt of human movement detected by a motion detector may indicate an unsafe scenario and may trigger transmission of an alert or warning. In another example, a rise in carbon monoxide levels with a sudden halt of movement detected by a motion detector may indicate a loss of consciousness of an individual due to carbon monoxide buildup. These are but a few examples of correlated events that may trigger a signal or warning, according to depicted method 600 for monitoring environment 303.

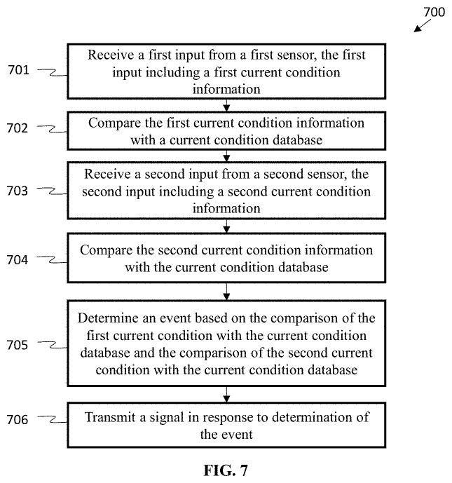

Referring now to FIG. 7, a flowchart 700 showing an exemplary method for monitoring environment 303 is depicted, according to one implementation of the present disclosure. At 701, hardware processor 120 receives a first input from a first sensor, the first input including a first current condition information. The first current condition information may reflect real time information of environment 303 including but not limited to at least one of a temperature information, a sound information, and a motion detection information, to name a few.

At 702, hardware processor 120 compares the first current condition information with current condition database 131. In some implementations, current condition database 131 may store baseline data or current condition threshold with which to compare environment's 303 collected current condition information. In some implementations, baseline data associated with an environment 303 may also include a history of various current condition information or data of environment 303. In some implementations, current condition database 131 includes a baseline or threshold range with which to compare current condition information associated with environment 303.

At 703, hardware processor 120 receives a second input from a second sensor, the second input including a second current condition information. At 704, hardware processor 120 compares the second current condition information with current condition database 131. The second current condition information may reflect real time information of environment 303 including but not limited to at least one of temperature information, sound information, and motion detection information, to name a few.

At 705, hardware processor 131 determines an event based on the comparison of the first current condition with the current condition database and the comparison of the second current condition with the current condition database. For example, based on comparison, the first input with the current condition information may be outside a baseline or current condition threshold which sets forth a standard range for environment 303. For example, the first current condition information of the first input may include a temperature data of environment 303. The current temperature data may be above or below a range of baseline or threshold temperature stored in current condition database 131. Based on the comparison of first current condition information with current condition database 131, hardware processor 120 may determine the first current condition information is outside of a standard range for environment 303.

Similar readings and comparisons apply to other current condition information associated with environment 303. For example, based on comparison, the second input with the second current condition information may fall outside a current condition threshold for environment 303 as set forth in current condition database 131. For example, the second current condition information of the second input may include smoke level or air quality data of environment 303. For example, air quality data may be measured with air quality index. The smoke level or air quality data may fall within or outside a range of safe or good air quality levels stored in current condition database 131. Based on the comparison of second current condition information to current condition database 131, hardware processor 120 may determine the second current condition information is outside of safe range for environment 303. Consequently, if the first comparison indicates that the temperature is far higher than standard, and if the second comparison indicates poor air quality levels, then hardware processor 131 may determine that event is a fire. In other words, the combination of a high temperature and poor air quality due smoke may be attributed to a fire. In some implementations, event may be one of a fire, a carbon monoxide buildup, a water leak, an environmental control system malfunction, and a shooting.

At 706, hardware processor 120 transmits a signal in response to determination of event. In some implementations, the signal may be an emergency request signal transmitted using one of a telephone, an internet connected computer, a mobile phone, and a global positioning system (GPS) device. As a result, emergency services, including first responders, will be dispatched directly to the location of the of the emergency incident. In some implementations, there may also be an alert on-site of environment 303, wherein the alert may be an audio alert, a visual alert, a computer signal alerts, or an emergency call. In some implementations, an audio alert may play over speakers for everyone in environment 303 to hear, or it may be broadcast wirelessly for individuals to hear. In some implementations, an alert may apply to a subsection of individuals present at environment 303 and only those within proximity will receive the alert. In some implementations, visual alerts may include flashing lights at environment 303. A computer signal alert may be a signal sent to a network-connected tool or equipment to shut down, cease operation, or change operational states. In some implementations, a computer signal may shut down a water main in the event of a water leak or burst pipe for instance, deactivate a piece of equipment, or activate a fan. These are merely examples and do not capture the full range and possible iterations of actions or effects an alert could include.

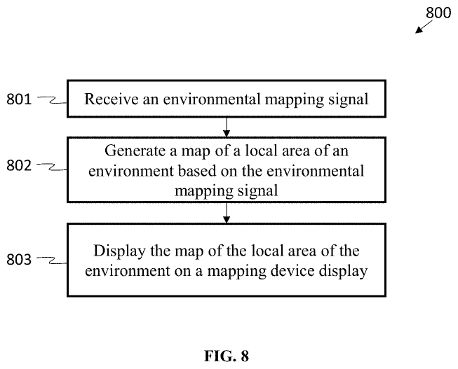

Referring now to FIG. 8, flowchart 800 shows an exemplary method of using a mapping device for monitoring an environment, according to one implementation of the present disclosure. In some implementations, environmental mapping device 260 includes mapping device display 261. In some implementations, mapping device 260 is connected to computing device 110 using wired technologies and/or wireless technologies. The method begins at 801, where environmental mapping device 260 includes mapping device hardware processor 270 executing mapping device executable code 290 to receive environmental mapping signal. In some implementations, mapping device executable code 290 includes mapping module 291 for execution by mapping device processor 270 to receive an environmental mapping signal transmitted using antenna 201, to generate a map of a local area of the environment based on the environmental mapping signal, and to display the map of the local area of the environment on mapping device display 261. In some implementations, mapping device 260 may be one of a cellular phone, a personal digital assistant (PDA), and a portable handheld device. In some implementations, mapping device 260 is integrated into a wearable device, such as a helmet, a pair of goggles or glasses, or a headset in another device worn by a person. Environmental mapping signal is transmitted using antenna array 201. In some implementations, antenna array 201 is an electrical wiring system of building environment 303. In some implementations, environmental mapping signal is transmitted using wireless technologies such as WiFi, Bluetooth, Bluetooth Low Energy (BLE), long range radio frequency (LoRa) technology, radio frequency identification (RFID) active and passive RFID tags, mobile phone connectivity, such as cellular, satellite communicates, LTE, etc.

At 802, mapping device hardware processor 270 generates a map of a local area of environment 303 based on environmental mapping signal. In some implementations, a map of a local area may be a floor plan that includes environment 303 and/or navigation directions to reach target location of environment 303 where emergency event occurred or is ongoing. In some implementations, where antenna array 201 is electrical wiring system of building environment 303, antenna array 201 transmits environmental mapping signal, thereby providing a layout of environment 303 since the transmitted signal is derived from environment's 303 electrical layout plan. In some implementations, generating a map is based on data gathered from the plurality of sensors and their associated locations within environment 303. Consequently, the plurality of sensors may be connected to a communication element for transmitting data and locations as they are integrated into various construction elements of building environment 303. For example, if sensors are integrated into light fixtures, door contacts, smart appliances, and light switches of target area of environment 303, the transmitted signals may generate additional details of layout that were not defined in the map generated from the electrical wiring. Together, the transmitted signals from electrical wiring and sensors integrated into construction elements of building environment 303 may generate a comprehensive map of a local area of environment 303.

At 803, mapping device hardware processor 270 displays the map of the local area of environment 303 on mapping device display 261. In some implementations, mapping device 260 with display 261 and speaker 263 is integrated into a wearable device, such as a helmet, a pair of goggles or glasses, a face shield, or a headset in another device worn by a person. In some implementations, the wearable device may further have a head-up display (HUD) or other integrated-display device such that the wearer may better navigate to the targeted area of the environment. For example, event may be a fire started in a fifth-floor apartment kitchen in environment 303. Mapping device 260 display 261 will display the generated map layout of the fifth floor of building environment 303 to assist rescue worker 155 to navigate the smoke-filled building to the target apartment's kitchen. Rescue worker 155 may wear a safety helmet with a HUD displaying the generated map layout, while earpiece speaker 263 dictates the directions to rescue worker 155. In some implementations, lidar may be used for distance detection, detecting location of doors, hallways, walls, etc. In some implementations, sonar may be used to map underwater environment 303. In one implementation, if event is a shooting at a school building environment 303, the electrical wiring and sensors integrated in fixtures, ballistic walls, switches, and more may again provide a layout of the school. Audio sensors may detect the location(s) of where shots were fired and designate the target areas. Additionally, collected current condition information compared with current condition database 131 may trigger remotely locking down areas of the building to isolate the shooter from others. Again, first responders/rescue workers 155 wearing helmets with display 261 will easily navigate the hallways to reach the target areas where shots were fired along with the location where shooter has been isolated.

From the above description, it is manifest that various techniques can be used for implementing the concepts described in the present application without departing from the scope of those concepts. Moreover, while the concepts have been described with specific reference to certain implementations, a person having ordinary skill in the art would recognize that changes can be made in form and detail without departing from the scope of those concepts. As such, the described implementations are to be considered in all respects as illustrative and not restrictive. It should also be understood that the present application is not limited to the particular implementations described above, but many rearrangements, modifications, and substitutions are possible without departing from the scope of the present disclosure.

What is claimed is:

1. A system for monitoring an environment, the safety system comprising:
a plurality of sensors;
a non-transitory memory storing an executable code; and
a hardware processor executing the executable code to:
receive a first input from a first sensor, the first input including a first current condition information;
compare the first current condition information with a current condition database;
receive a second input from a second sensor, the second input including a second current condition information;
compare the second current condition information with the current condition database;
determine an event based on the comparison of the first current condition with the current condition database and the comparison of the second current condition with the current condition database; and
transmit a signal in response the determination of the event.

2. The system of claim 1, wherein the plurality of sensors is communicatively connected using wires.

3. The system of claim 2, wherein the wires are a part of the electrical wiring of a building.

4. The system of claim 1, wherein the safety system further includes an antenna array and the hardware processor further executes the executable code to:
transmit an environmental mapping signal using the antenna array,
wherein the environmental mapping signal is transmitted and received using wireless technologies.

5. The system of claim 4, wherein the environment is a building and the antenna array is an electrical wiring system of the building.

6. The system of claim 4, wherein the system further comprises an environmental mapping device comprising:
a mapping device display;
a mapping device non-transitory memory storing a mapping device executable code; and
a mapping device hardware processor executing the mapping device executable code to:
receive the environmental mapping signal;
generate a map of a local area of the environment based on environmental mapping signal; and
display the map of the local area of the environment on the mapping device display.

7. The system of claim 1, wherein the environment is a building and the plurality of sensors are integrated into one or more construction elements of the building.

8. The system of claim 7, wherein the one or more construction elements of the building integrating the sensors include at least one of an electrical outlet, a light switch, a light fixture, an electrical door sensor, and an integrated smart device.

9. The system of claim 8, wherein the integrated smart device is one of a smart appliance, a smart thermostat, a smart speaker, a smart door opener, a smart door lock, a smart doorbell, and a smart building alarm system.

10. The system of claim 1, wherein the environment is a building and the event is one of a fire, a carbon monoxide buildup, a water leak, and an environmental control system malfunction.

11. The system of claim 1, wherein the plurality of sensors includes at least one of a light sensor, a gas sensor, a sound sensor, a temperature sensor, and a motion detector.

12. The system of claim 1, wherein the environment is a swimming pool and the event is an individual in distress, and wherein the plurality of sensors include at least one of a tidal sensor, an audible sensor, an electrical sensor, a volumetric sensor, an energized water sensor, and an electrified water sensor.

13. The system of claim 1, wherein the signal is an emergency request signal transmitted using one of a telephone, an internet connected computer, a mobile phone, and a global positioning system (GPS) device.

14. A method for monitoring an environment with a monitoring device including a non-transitory memory and a hardware processor, the method comprising:
receiving, using the hardware processor, a first input from a first sensor, the first input including a first current condition information;
comparing, using the hardware processor, the first current condition information with a current condition database;
receiving, using the hardware processor, a second input from a second sensor, the second input including a second current condition information;
comparing, using the hardware processor, the second current condition information with the current condition database;
determining, using the hardware processor, an event based on the comparison of the first current condition with the current condition database and the comparison of the second current condition with the current condition database; and
transmitting, using the hardware processor, a signal in response to determination of the event.

15. The method of claim 14, further comprising:
transmitting, using an antenna array, an environmental mapping signal using the antenna array.

16. The method of claim 15, wherein the environment is a building and the antenna array is an electrical wiring system of the building.

17. The method of claim 15, wherein the system further comprises an environmental mapping device having a mapping device display, the method further comprising:
receiving, using the environmental mapping device, the environmental mapping signal;
generating a map of a local area of the environment based on environmental mapping signal; and
displaying the map of the local area of the environment on the mapping device display.

18. The method of claim 14, wherein the environment is a building and the event is one of a fire, a carbon monoxide buildup, a water leak, and an environmental control system malfunction.

19. The method of claim 14, wherein the first sensor is one of a light sensor, a gas sensor, a sound sensor, a temperature sensor, and a motion detector and the second sensor is one of a light sensor, a gas sensor, a sound sensor, a temperature sensor, and a motion detector.

20. The method of claim 14, wherein the environment is a swimming pool and the event is an individual in distress.
